(19) United States
(12) Patent Application Publication
(10) Pub. No.: US 2026/0309954 A1
(43) Pub. Date: Oct. 8, 2026

(54) CABLE MANAGEMENT SYSTEM

(71) Applicant: CommScope Technologies LLC, Claremont, NC (US)

(72) Inventors: Alejandro Jose AVILA, Juarez (MX); Jesus Gustavo PURECO CHICO, Juarez (MX); Ivan Rene SANCHEZ, Juarez (MX); Barry Wayne ALLEN, Siler City, NC (US)

(21) Appl. No.: 19/640,769

(22) Filed: Apr. 7, 2026

Related U.S. Application Data
(60) Provisional application No. 63/784,428, filed on Apr. 7, 2025.

(51) Int. Cl. G02B 6/44; B65H 75/44

(52) U.S. Cl. CPC G02B 6/4458; B65H 75/4457; B65H 75/4476

(57) ABSTRACT

The present disclosure relates to a cable coil support structure including a frame component including a length that extends along a reference plane between first and second end portions. The frame component includes a first frame member and a second frame member that are secured in alignment with each other along the reference plane to define the frame component. When the first and second frame members are secured in alignment with each other along the reference plane, the first frame member defines the first end portion of the frame component and the second frame member defines the second end portion of the frame component.

### CROSS-REFERENCE TO RELATED APPLICATIONS

This application claims the benefit of and priority to U.S. Provisional Patent Application Ser. No. 63/784,428, filed Apr. 7, 2025, the disclosure of which is herein incorporated by reference in its entirety.

### BACKGROUND

Fiber optic communication systems allow service providers to deliver high bandwidth communication capabilities to customers. Fiber optic communication systems employ a distribution network of fiber optic cables to transmit large volumes of data over long distances. A drop cable is typically the last leg of the distribution network before reaching an end subscriber such as a house, apartment, office, place of business, and the like. Typically, a drop cable is run from an optical terminal before reaching an end subscriber location. While optical terminals are often installed adjacent an outer edge of a fiber distribution network, it will be appreciated that optical terminals can also be installed at other locations within a fiber distribution network.

Optical terminals can be mounted on a variety of structures in the field including walls, poles, cables, and the like. In some instances, mounting brackets can be used to mount the optical terminals to a variety of structures in the field. Excess cable length is often required to be managed outside the terminals. Such excess cable length can be coiled about a cable manager. In some instances, the terminal is mounted at a location within the coil.

### SUMMARY

One aspect of the present disclosure relates to a device for coiling slack cable that includes a central platform that is forwardly offset from cable management hook mounting locations of the device. In one example, a terminal can be mounted to the platform either directly or via an adapter bracket.

Another aspect of the present disclosure relates to a device for coiling slack cable that includes a cable coil support structure that has a two-location cable engagement configuration arranged such that the slack cable is coiled about only first and second cable management hooks mounted on a frame component of the cable coil support structure without any additional hooks for engaging the coiled slack cable.

Another aspect of the present disclosure relates to a device for coiling slack cable that includes a frame component and cable management hooks that are reversibly mountable to the frame component.

Another aspect of the present disclosure relates to a device for coiling slack cable that includes a cable coil support structure including a frame component including a length that extends along a reference plane between first and second end portions. The frame component includes a first frame member and a second frame member that are secured in alignment with each other along the reference plane to define the frame component. When the first and second frame members are secured in alignment with each other along the reference plane the first frame member defines the first end portion of the frame component, and the second frame member defines the second end portion of the frame component. In one example, the first and second frame members are identical. In one example, when disassembled, parts of the cable coil support structure can be packaged in a compact configuration (e.g., nested, mated, overlapping, etc.) for shipping. In one example, the first and second frame member mount to a rear device mounting bracket for attaching the device to a structure such as a pole. In one example, the rear device mounting bracket is located at a central/mid region of the frame component. In one example, the first and second frame members can be attached to the rear device mounting bracket before or after the rear device mounting bracket is secured to the structure. In one example, inner ends of the first and second frame members cooperate to define an opening for accessing a structure fastening region of the rear device mounting bracket. In one example, inner ends of the first and second frame members engage one another via an interlock interface (e.g., a pivot interlock interface).

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the examples disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of a cable management device for coiling slack cable in accordance with the principles of the present disclosure shown including a first terminal mounting bracket;

FIG. 2 is a perspective view of the cable management device of FIG. 1 with a dome-style terminal secured to the device and cable coiled about the device;

FIG. 3 is a perspective view of the cable management device of FIG. 1 shown including a second terminal mounting bracket;

FIG. 4 is a perspective view of the cable management device of FIG. 3 with a box-style terminal secured to the device and cable coiled about the device;

FIG. 5 is a perspective view of the cable management device of FIG. 1 shown including a third terminal mounting bracket;

FIG. 6 is a perspective view of the cable management device of FIG. 5 with another box-style terminal secured to the device;

FIG. 7 is a side view of the cable management device of FIG. 1;

FIG. 8 is a front view of the cable management device of FIG. 1;

FIG. 9 is a front, side perspective view of a first frame member of the cable management device of FIG. 1;

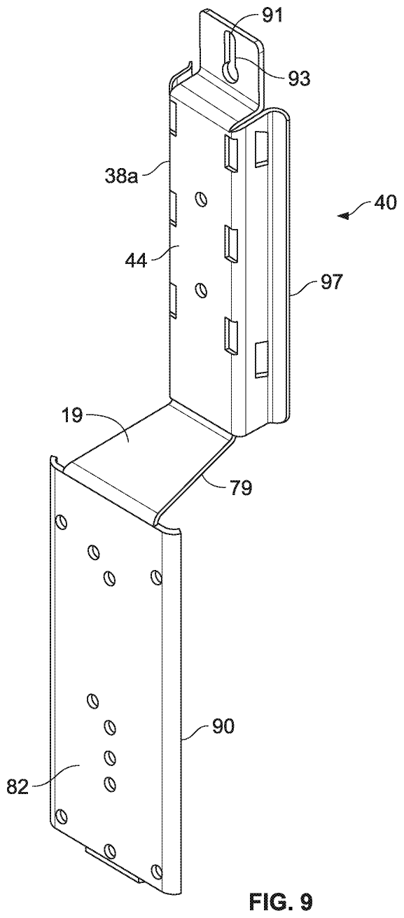

FIG. 10 is a side view of the first frame member of FIG. 9;

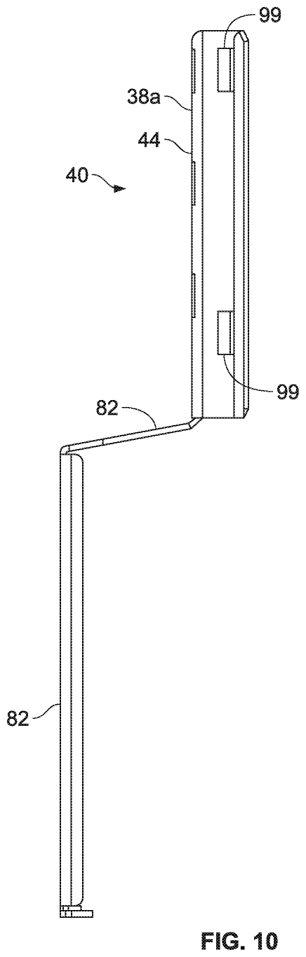

FIG. 11 is a front view of the first frame member of FIG. 9;

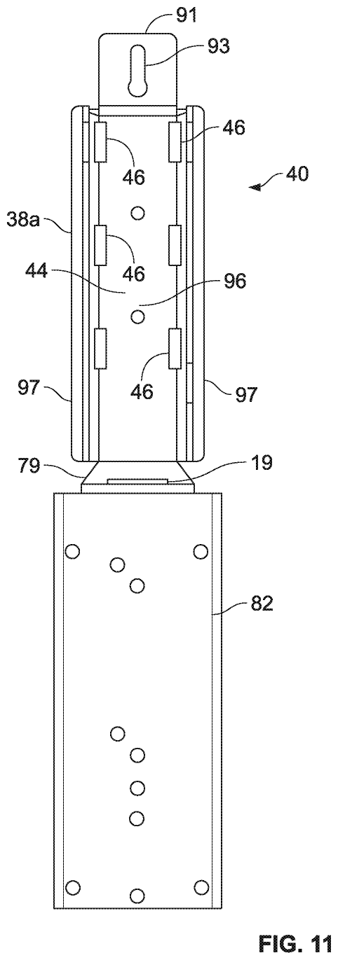

FIG. 12 is an end view of the first frame member of FIG. 9;

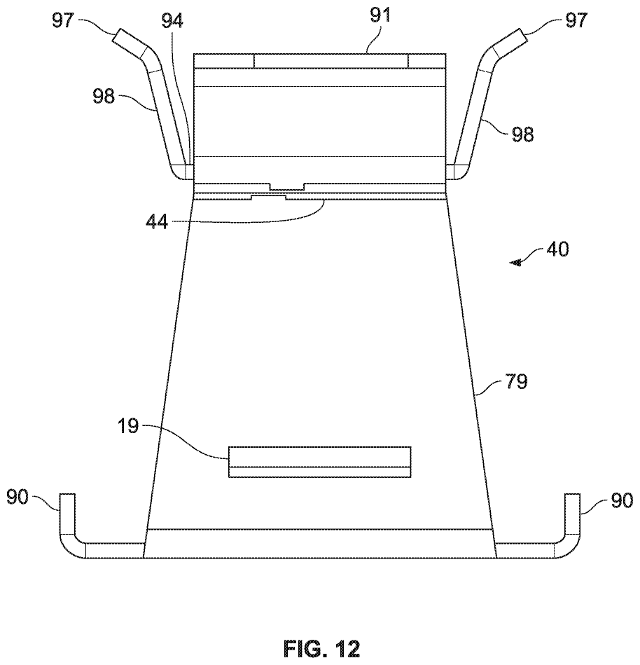

FIG. 13 is a perspective view of a cable management hook of the cable management device of FIG. 1;

FIG. 14 is a side view of the cable management hook of FIG. 13;

FIG. 15 is a front view of the cable management hook of FIG. 13;

FIG. 16 is a top view of the cable management hook of FIG. 13;

FIG. 17 is an exploded, perspective view of another cable management device in accordance with the principles of the present disclosure including a first adapter bracket used for mounting a dome-style terminal;

FIG. 18 is a perspective view depicting a frame component of the cable management device of FIG. 17 shown secured to a pole;

FIG. 19 is a perspective view including the frame component of FIG. 18 with an offset bracket and cable management hooks mounted thereto;

FIG. 20 is a perspective view of the cable management device of FIG. 17 shown secured to a pole with the dome-style terminal mounted thereto;

FIG. 21 is a perspective view of the arrangement of FIG. 20 with the dome-style terminal offset from the cable management device;

FIG. 22 is a perspective view of the arrangement of FIG. 21 with a base of the dome-style terminal secured to the cable management device and with a clamp of the dome-style terminal staged on the cable management device;

FIG. 23 is a side view of a cable management device having a frame component including a tapered back side and a rear device mounting bracket;

FIG. 24 is a side view of a cable management device including a rear device mounting bracket and a frame component having a non-tapered back side;

FIG. 25 is a side view of a cable management device including a frame component that mounts directly to a structure such as a pole without using an intermediate rear device mounting bracket;

FIG. 26 is a perspective view of the cable management device of FIG. 25 shown secured to the pole by straps routed through slots in the frame component;

FIG. 27 is a perspective view of the arrangement of FIG. 26 with a lower one of the cable management hooks mounted in a reverse configuration;

FIG. 28 is a perspective view of the arrangement of FIG. 27 with the dome-style closure at an alternative, higher mounting configuration on the frame component;

FIG. 29 is an exploded, perspective view of the cable management device of FIG. 17 including a second adapter bracket for mounting a box-style terminal to the frame component;

FIG. 30 is a perspective view of the cable management device of FIG. 17 shown disassembled and arranged in a compact configuration for shipping;

FIG. 31 is a front view of the arrangement of FIG. 30;

FIG. 32 is a side view of the arrangement of FIG. 30;

FIG. 33 is a top view of the arrangement of FIG. 30;

FIG. 34 is a partially assembled view of the arrangement of FIG. 30;

FIG. 35 is a front, perspective view of a frame component having a pivot interlock interface in accordance with the principles of the present disclosure;

FIG. 36 is a perspective view of the pivot interlock interface of FIG. 35 shown disconnected;

FIG. 37 is a perspective view of the pivot interlock interface of FIG. 35 shown in the process of being interlocked;

FIG. 38 is a perspective view of the pivot interlock interface of FIG. 35 shown interlocked;

FIG. 39 is a front, perspective view of a frame component having another pivot interlock interface in accordance with the principles of the present disclosure;

FIG. 40 is a perspective view of the pivot interlock interface of FIG. 39 shown disconnected;

FIG. 41 is a perspective view of the pivot interlock interface of FIG. 39 shown in the process of being interlocked;

FIG. 42 is a perspective view of the pivot interlock interface of FIG. 39 shown interlocked;

FIG. 43 is a front view of the pivot interlock interface of FIG. 39 shown interlocked;

FIG. 44 is a cross-sectional view of the pivot interlock interface of FIG. 39 shown interlocked;

FIG. 45 is another cross-sectional view of the pivot interlock interface of FIG. shown interlocked and further secured with a threaded fastener;

FIG. 46 is a front, perspective view of a frame component having another pivot interlock interface in accordance with the principles of the present disclosure;

FIG. 47 is a perspective view of the pivot interlock interface of FIG. 46 shown disconnected;

FIG. 48 is a perspective view of the pivot interlock interface of FIG. 46 shown in the process of being interlocked;

FIG. 49 is a perspective view of the pivot interlock interface of FIG. 46 shown interlocked;

FIG. 50 is a perspective view of a frame component in accordance with the principles of the present disclosure having a rear mounting opening aligned with a head of a threaded fastener secured to pole;

FIG. 51 is a perspective view of the arrangement of FIG. 50 with the head of the threaded fastener extending through an enlarged central opening of the rear mounting opening;

FIG. 52 is a perspective view of the arrangement of FIG. 50 with the threaded fastener received within a narrowed upper region of the rear mounting opening; and

FIG. 53 is a perspective view of the frame component of FIG. 50 secured to the pole with a strap routed through lateral slots defined by the frame component.

### DETAILED DESCRIPTION

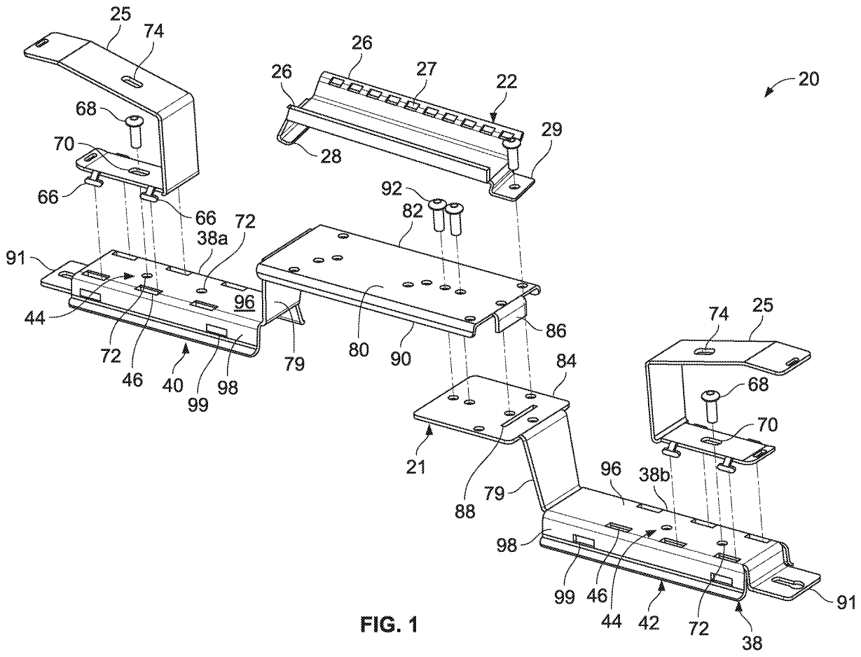

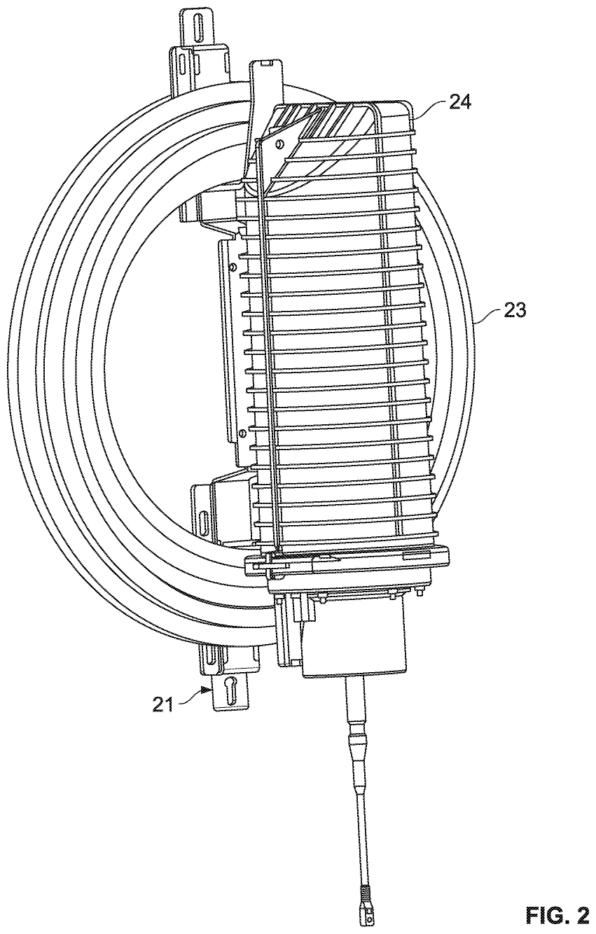

FIG. 1 depicts cable management device 20 in accordance with the principles of the present disclosure for storing slack cable (e.g., telecommunication cable such as fiber optic cable or copper cable). The cable management device 20 includes a cable coil support structure 21 shown in combination with a first terminal mounting bracket 22 for use in mounting a dome-style terminal 24 (see FIG. 2) to the cable coil support structure 21. The cable coil support structure 21 has a two-location cable engagement configuration arranged such that slack cable 23 is coiled about only the first and second cable coil support locations (e.g., cable management hooks 25).

The first terminal mounting bracket 22 has an open channel configuration adapted to engage/receive a base of the dome-style terminal 24. Channel flanges 26 of the terminal mounting bracket 20 extend to define strap receiving openings 27 adapted to receive straps for securing the base of the dome-style terminal to the first terminal mounting bracket 22. The first terminal mounting bracket 22 has an elongate configuration with a hook 28 at one end adapted to be received within a corresponding slot 19 defined by the coil support structure 21 and a tab 29 at an opposite end. The tab 29 defines a fastener opening for receiving a fasteners such as a bolt or screw that can be secured within a corresponding opening defined by the coil support structure 21. Hence, the first terminal mounting bracket 22 can be secured to the coil support structure 21 by fasteners, interlocks or a combination thereof.

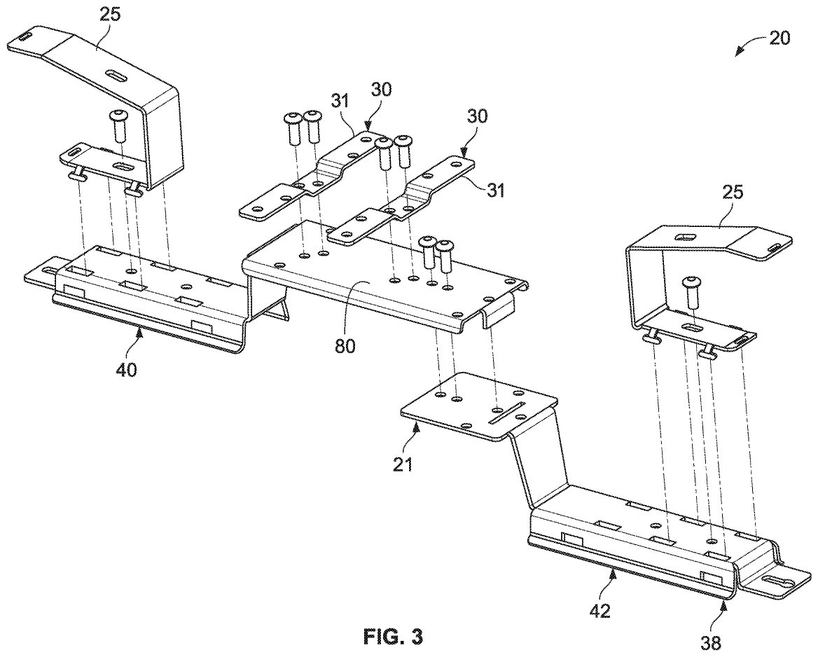

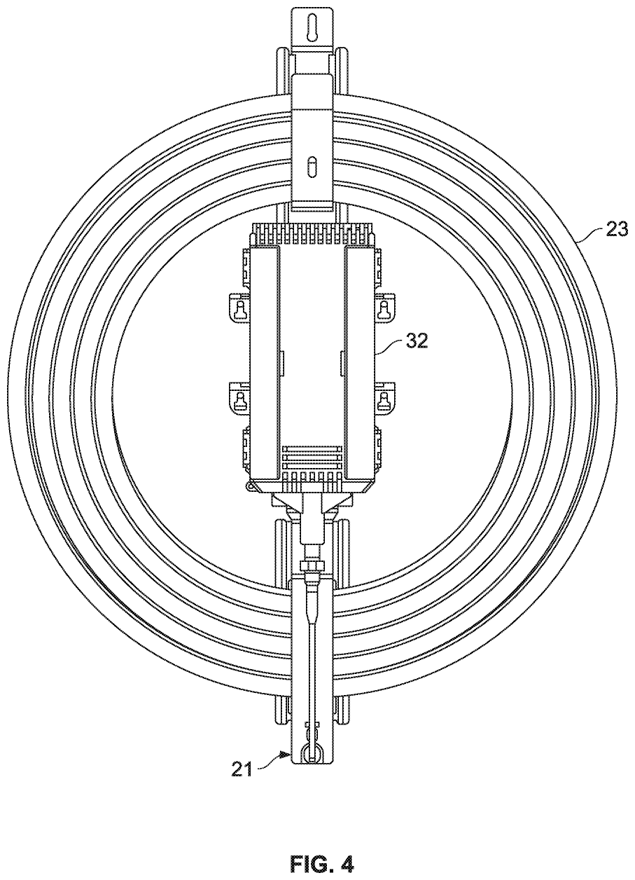

FIG. 3 depicts the cable management device 20 with second terminal mounting brackets 30 adapted for securing a box-style terminal 32 (see FIG. 4) to the coil support structure 21. The second terminal mounting brackets 30 include two spaced-apart, parallel bracket elements 31 that can be fastened to the coil support structure 21 by fasteners such as threaded fasteners (e.g., bolts, screws, etc.). It will be appreciated that the box-style terminal 32 can be secured to the bracket elements 31 by fasteners such as threaded fasteners.

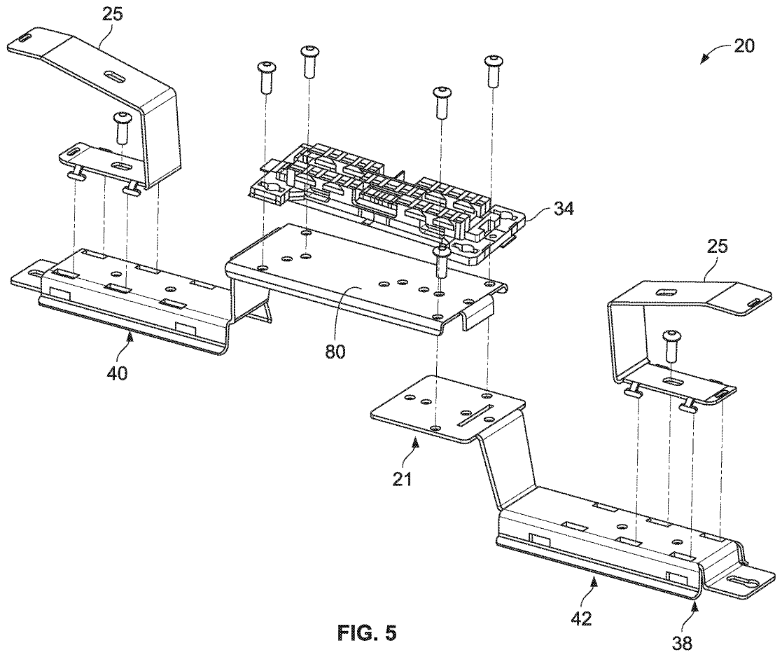

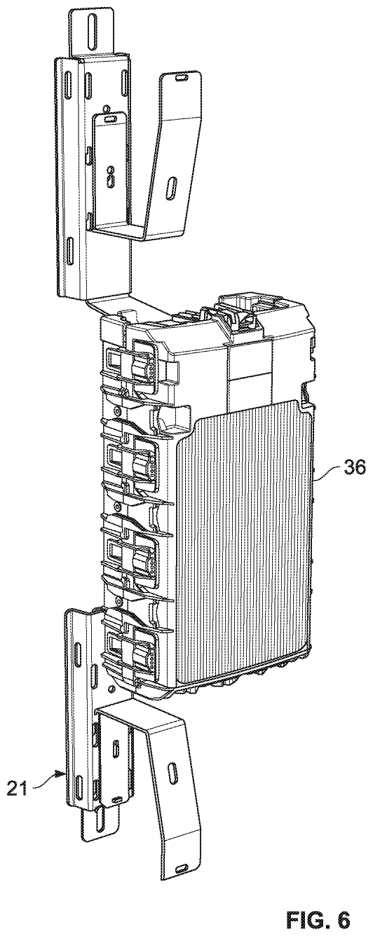

FIG. 5 depicts the cable management device 20 with a third terminal mounting bracket 34 adapted for securing another box-style terminal 36 (see FIG. 6) to the coil support structure 21. Example configurations for the third terminal mounting bracket 34 are disclosed by U.S. Pat. No. 11,428,886 and PCT International Publication No. WO 2021/092177 the disclosures of which are hereby incorporated by reference in their entireties. It will be appreciated that the third terminal mounting bracket 34 can be secured to the coil support structure 21 by fasteners such as threaded fasteners.

It will be appreciated that the terminal mounting brackets and their corresponding terminals are attached to the coil support structure 21 at a central or mid-region of the coil support structure 21 (e.g., at a central or mid-region of a frame component 38 of the coil support structure) such that the terminals are located in front of a central region of the coil of slack cable 23. For example, as depicted from a front view, the terminals align with or are positioned directly in front of an open central region of the coil of cable. Thus, the coiled cable does not block or interfere with access to the terminals.

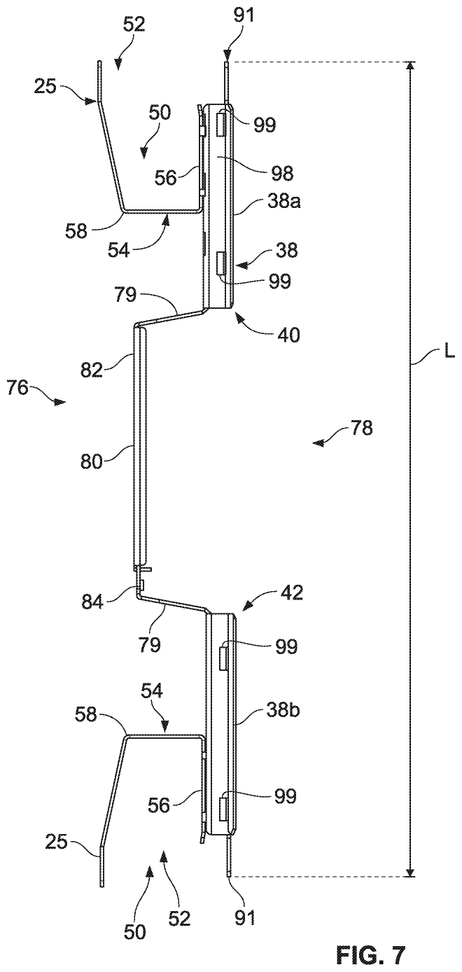

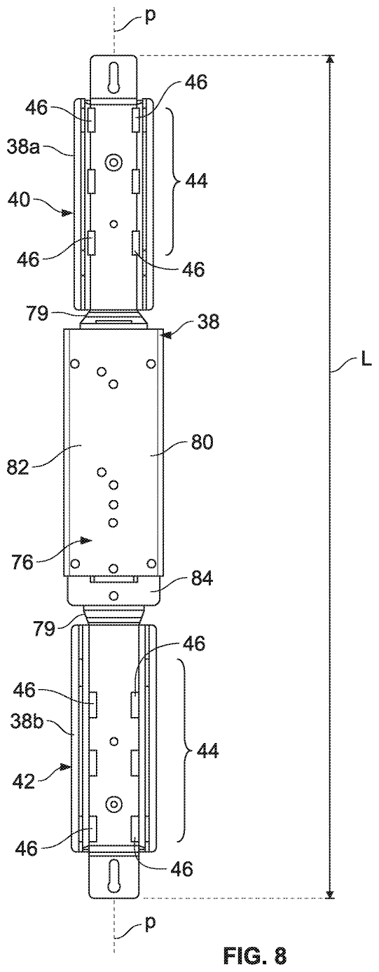

Referring back to FIG. 1, the cable coil support structure 21 includes the frame component 38. The frame component 38 includes a length L (see FIGS. 7 and 8) that extends along a reference plane P (see FIG. 8) between first and second end portions 38a, 38b. The frame component 38 includes a first frame member 40 and a second frame member 42 that are secured in alignment with each other along the reference plane P to define the frame component 38. When the first and second frame members 40, 42 are secured in alignment with each other along the reference plane P the first frame member 40 defines the first end portion 38a of the frame component 38 and the second frame member 42 defines the second end portion 38b of the frame component 38. The first and second end portions 38a, 38b each including a hook mounting region 44 (see FIG. 8) including a plurality of hook mounting locations spaced-apart along the length L of the frame component 38. The hook mounting locations can be defined by sets of slots 46.

Referring still to FIG. 1, a first one of the cable management hooks 25 mounts at the hook mounting region 44 of the first end portion 38a of the frame component 38 and a second one of the cable management hooks 25 mounts at the hook mounting region 44 of the second end portion 38b of the frame component 38. As described above, the cable coil support structure 21 has a two-location cable engagement configuration arranged such that the slack fiber optic cable is coiled about only the first and second cable management hooks 25 mounted on the frame component 38 without any additional hooks for engaging the coiled slack fiber optic cable 23 (e.g., see FIGS. 2 and 4).

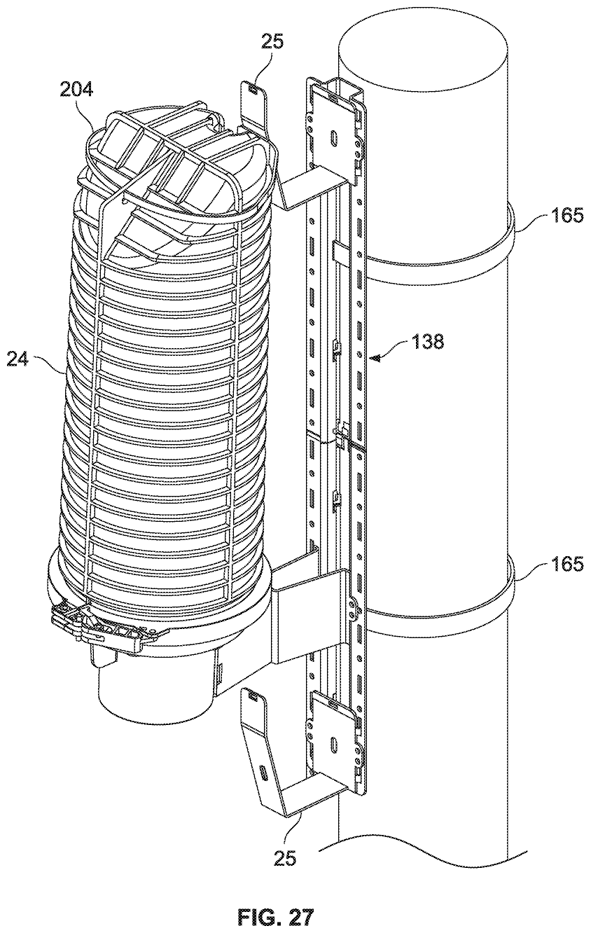

The cable management hooks 25 each include a cable receiving region 50 having an open end 52 and a closed end 54. The cable management hooks 25 are configured to reversibly mount to the hook mounting regions 44. For example, the cable management hooks 25 can be mounted to the hook mounting regions 44 in a first configuration in which the open ends 52 face outwardly away from the central region of the frame component 38 (see FIGS. 2, 4 and 6). Additionally, at least one of the cable management hooks 25 can be mounted to one of the hook mounting regions 44 in a second configuration in which the open end 52 faces inwardly toward the central region of the frame component 38. For example, FIG. 27 depicts an arrangement in which the lower cable management hook 25 is mounted with the open end 52 facing inwardly and the upper cable management hook 25 is mounted with the open end 52 facing outwardly. In this type of configuration, each of the cable management hooks 25 can support a portion of the total weight of the coiled cable.

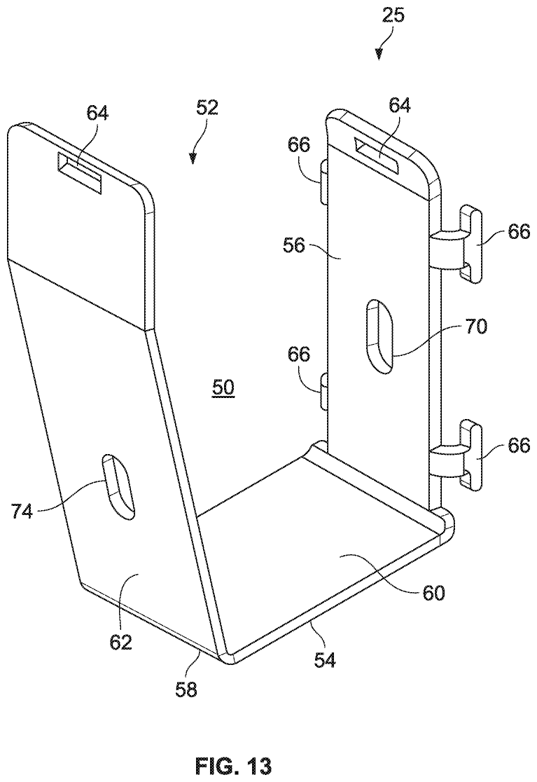

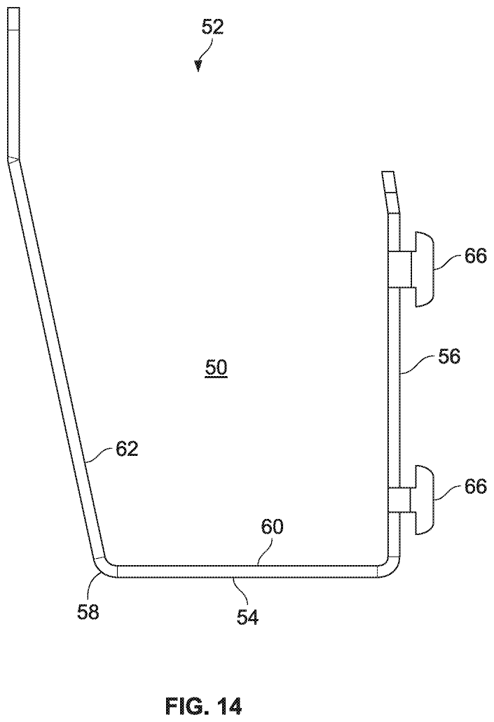

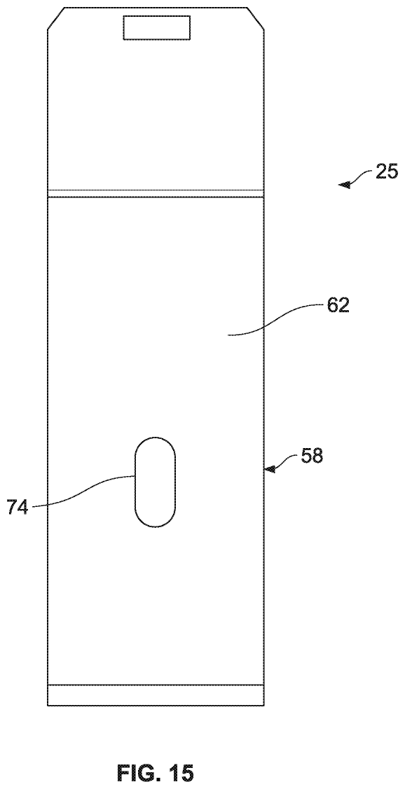

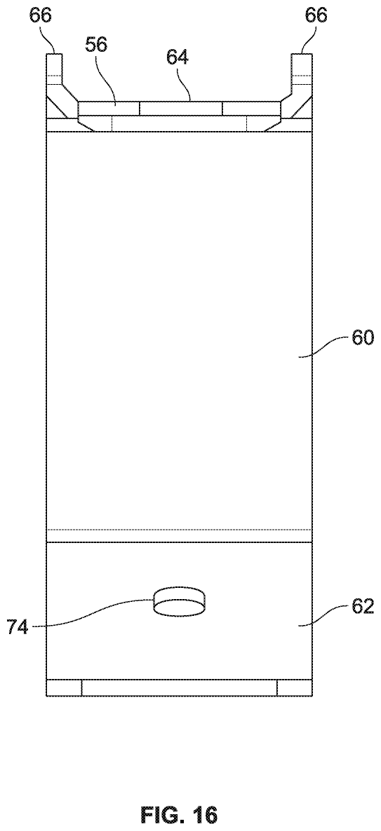

Referring to FIGS. 13-16, the cable management hooks 25 each include a base 56 and a forward extension 58 that projects from one end of the base 56. The cable receiving region 50 is defined between the base 56 and the forward extension 58. The forward extension 58 includes a first portion 60 that extends forwardly from the base 56 forms the closed end 54, and a second portion 62 that extends from the first portion 60 and opposes the base 56. Strap receiving slots 64 are defined through the hooks 25 adjacent free ends of the base 56 and the second portion 62. The second portion 62 has a longer length than the base 56. The base 56 is adapted to be secured to the hook mounting regions 44. For example, the base 56 includes retention tabs 66 that fit in the slots 46 of the hook mounting regions 44 to secure the cable management hook 25 to the hook mounting regions 44. The retention tabs 66 project rearwardly from side edges of the base 56. The retention tabs have T-shaped profiles that allow the cable management hooks 25 to be reversible mountable at the hook mounting regions 44. The cable management hooks 25 can further be secured to the hook mounting regions 44 by fasteners 68 (see FIG. 1) such as threaded fasteners that extend through base openings 70 defined by each base 56 and that engage corresponding fastener openings 72 associated with the different hook mounting locations of the hook mounting regions 44. In certain examples, the fastener openings 72 can be internally threaded. In other examples, the fasteners and 68 can engage nuts located at back sides of the frame component 38. In one example, the base openings 70 can be elongate in an orientation along the length of each base 56. The second portions 62 of the cable management hooks 25 can further define access openings 74 in general alignment with the base openings 70 for facilitating tool access with respect to the fasteners 68. For example, the access openings 74 can be configured to receive a tool such as a screwdriver used to install or remove the fasteners 68.

Referring to FIGS. 7 and 8, the frame component 38 has a front side 76 and a back side 78. The back side 78 is adapted to face toward a structure such as a pole when the device is secured to the structure. The frame component 38 includes a central front platform 80 to which adapter brackets can be mounted. Adapter brackets are brackets used to facilitating mounting other structures to the front platform 80. Example adapter brackets include the first terminal mounting bracket 22, the second terminal mounting brackets 30 and the third terminal mounting bracket 34. The central front platform 80 is forwardly offset with respect to the first and second end portions 38a, 38b of the frame component 38 by forward/rearward offset sections 79 of the frame component 38.

The central front platform 80 includes a first platform section 82 defined by the first frame member 40 and a second platform section 84 defined by the second frame member 42. The first platform section 82 overlaps the second platform section 84 when the first and second frame members 40, 42 are secured together. The first platform section 82 includes an end tab 86 that fits in a slot 88 defined by the second platform section 84. The first platform section 82 includes rearwardly projecting longitudinal edge rails 90 between which the second platform section 84 extends. One or more fasteners 92 (e.g., threaded fasteners) are further provided for securing the first and second platform sections 82, 84 together.

The first and second end portions 38a, 38b of the frame component 38 each define a rearwardly facing channel 94 formed by a front wall 96 and two rearwardly projecting side legs 98. The hook mounting slots 46 are defined through the front walls 96 and strap receiving slots 99 (e.g., for strapping the frame component 38 to a pole) are defined through the side legs 98. The side legs 98 extend along the length of the end portions 38a, 38b and include feet 97 adapted to engage a structure to which the frame component 38 is attached (e.g., wall, pole or other structure).

The frame component 38 includes device mounting tabs 91 at the first and second end portions 38a, 38b. The device mounting tabs 91 are rearwardly offset from the front walls 96. The device mounting tabs 91 defining fastener openings 93 for receiving fasteners (e.g., threaded fasteners) for use in securing the cable management device 20 to the structure such as a wall, pole or other structure.

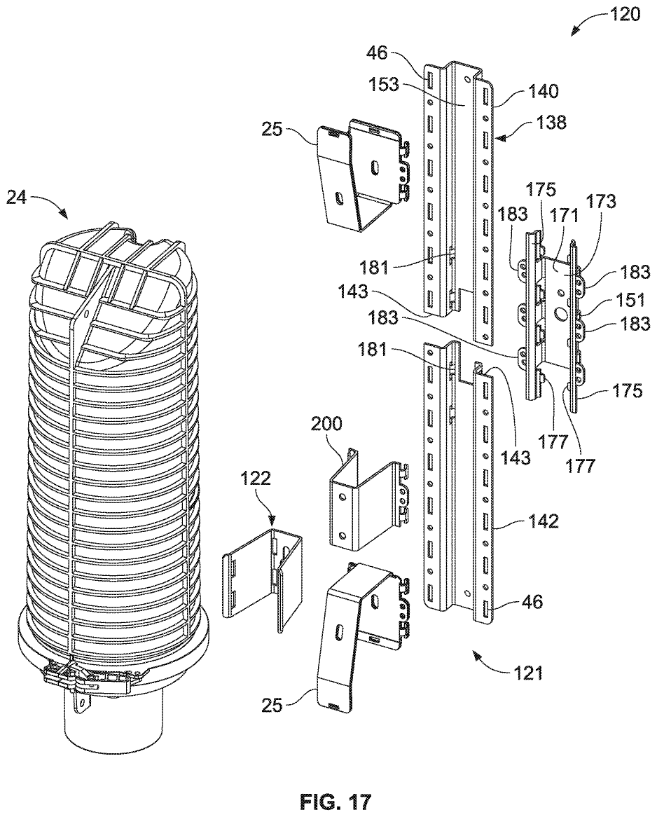

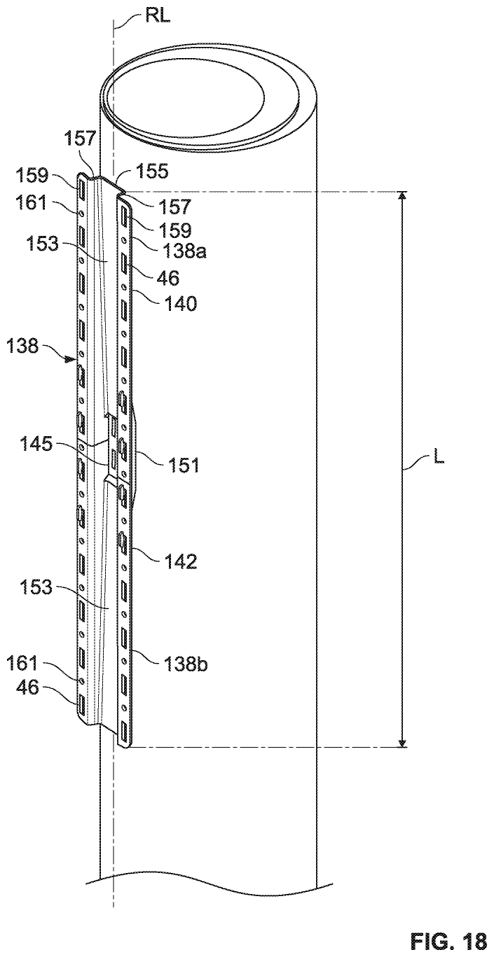

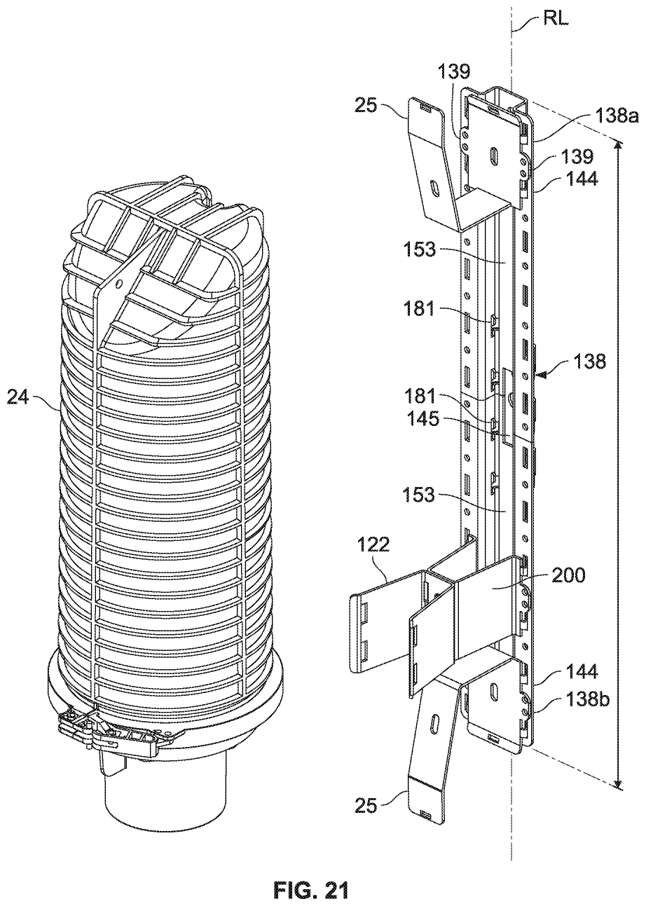

FIG. 17 depicts another cable management device 120 in accordance with the principles of the present disclosure for storing slack cable (e.g., telecommunication cable such as fiber optic cable or copper cable). The cable management device 120 includes a cable coil support structure 121 shown in combination with a first terminal mounting bracket 122 for use in mounting the dome-style terminal 24 to the cable coil support structure 121. The cable coil support structure 121 includes the frame component 138. The frame component 138 includes a length L that extends along a reference line RL (see FIGS. 18 and 21) between first and second end portions 138a, 138b. The frame component 138 includes a first frame member 140 and a second frame member 142 that are secured in co-axial alignment with each other along the reference line RL to define the frame component 138. When the first and second frame members 140, 142 are secured in co-axial alignment with each other along the reference line RL, the first frame member 140 defines the first end portion 138a of the frame component 138 and the second frame member 142 defines the second end portion 138b of the frame component 138. The first and second end portions 138a, 138b each include a hook mounting region 144 including a plurality of hook mounting locations spaced-apart along the length L of the frame component 138. The hook mounting locations can be defined by sets of slots such as the slots 46. Cable management hooks such as the cable management hooks 25 can mount at the hook mounting regions 144. The cable coil support structure 121 can have a two-location cable engagement configuration arranged such that slack cable is coiled about only two cable coil support locations (e.g., first and second cable management hooks 25).

In the depicted example, the first and second frame members 140, 142 have identical configurations. The first and second frame members 140, 142 can include inner ends 143 (see FIG. 17) that are connected together to form the frame component 138. The inner ends 143 can be coupled directly together (e.g., via an interlock, an overlap, via the use of fasteners, etc.) or and/or can be coupled together by an additional component such as a device mounting bracket 151. In the depicted example, the frame component 138 has a consistent transverse cross-section (e.g., cross-sectional profile) along its entire length L and can be referred to as a uni-bar, unit-strut, uni-member or like terms. When the inner ends 143 are coupled together, the inner ends 143 can cooperate to define a fastener access opening 145 that provides access to a structure (e.g., a device mounting bracket 151) that may be mounted behind the frame component 138. For example, the fastener access opening 145 can be configured to allow tool access (e.g., wrench or screwdriver access) to fasteners used to secure the device mounting bracket 151 to a structure such as a wall or pole.

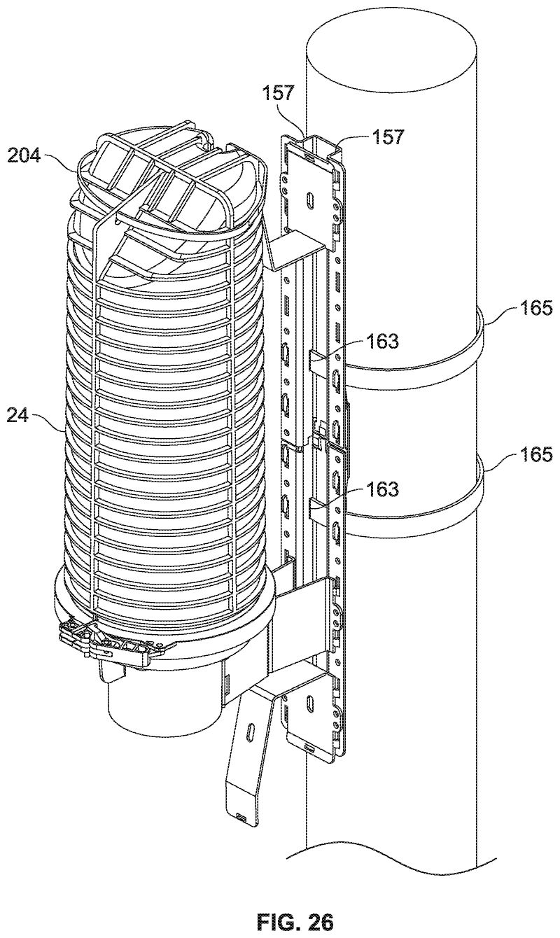

The first and second frame members 140, 142 each have a front side and a back side. The back sides are adapted to face toward a structure such as a pole when the cable management device 120 is secured to the structure. The first and second frame members 140, 142 each have a frame profile defining a longitudinal channel 153. Open sides of the longitudinal channels 153 face forwardly (e.g., outwardly from the pole as shown at FIG. 18). The frame profile is defined by a rear wall 155, channel-defining legs 157 that project forwardly from the rear wall 155, and front flanges 159 that project laterally outwardly from forward ends of the legs 157. The hook mounting regions 144 include hook mounting slots 46 defined through the front flanges 159. The cable management hooks 25 can include retention tabs 66 that fit in the slots 46 to secure the cable management hooks 25 to the hook mounting regions 144. The retention tabs can have T-shaped profiles that allow the cable management hooks 25 to be reversible mountable at the hook mounting regions 144. The slots 46 can be defined by the flanges 159 along the entire length of the frame component 138 to allow for the attachment of other structures (e.g., brackets) at locations longitudinally between the end portions 138a, 138b of the frame component 138. Fastener openings 161 can also be defined through the flanges 159 for receiving fasteners for further securing the hooks 25 or other structures to the frame component 138. In the depicted example of FIG. 21, the hooks 25 include side tabs 139 defining fastener openings that align with the fastener openings 161 when the hooks are secured to the frame component 138 by the retention tabs. In this way, fasteners can be used to prevent the retention tabs from inadvertently disengaging from their corresponding slots 46. The legs 157 can also define strap-receiving slots 163 for receiving straps 165 (see FIG. 26) that can also be used to secure or further secure the frame component 138 to a pole.

The device mounting bracket 151 has a front side and a back side. The back side is adapted to face toward a structure such as a pole when the device is secured to the structure. The first and second frame members 140, 142 mount at the front side of the device mounting bracket 151. The device mounting bracket 151 has a forward-facing channel 171 that receives the back sides of the first and second frame members 140, 142. The front flanges 159 of the first and second frame members 140, 142 are secured to the device mounting bracket 151 by fasteners and/or by an interlock interface such as by a snap-fit interlock. In the depicted example, the device mounting bracket 151 includes a rear wall 173 defining fastener openings for allowing fasteners to be used to secure the device mounting bracket 151 to a pole or other structure. Longitudinally extending legs 175 project forwardly from the rear wall 173. Interlock tabs 177 project laterally inwardly from the legs 175 and are adapted to fit within corresponding slots 181 defined through the legs 157 of the first and second frame members 140, 142 adjacent their inner ends to provide an interlock between the first and second frame members 140, 142 and the device mounting bracket 151. Fastening tabs 183 project laterally outwardly from the legs 175. The fastening tabs 183 define fastener openings adapted to align with the fastener openings 161 of the front flanges 159 to facilitate securing the first and second frame members 140, 142 to the device mounting bracket 151 via fasteners such as threaded fasteners. FIG. 18 shows the first and second frame members 140, 142 secured together by the device mounting bracket 151 and also secured to a pole by the device mounting bracket 151.

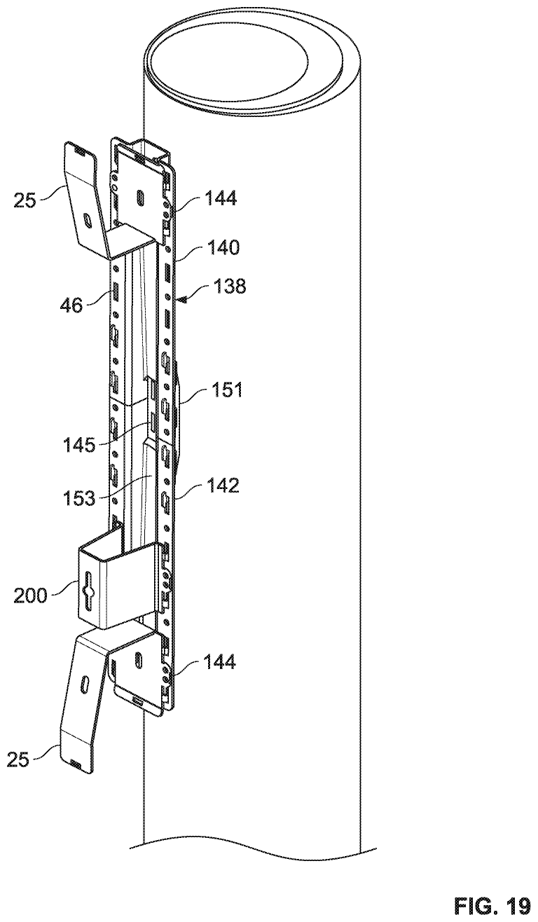

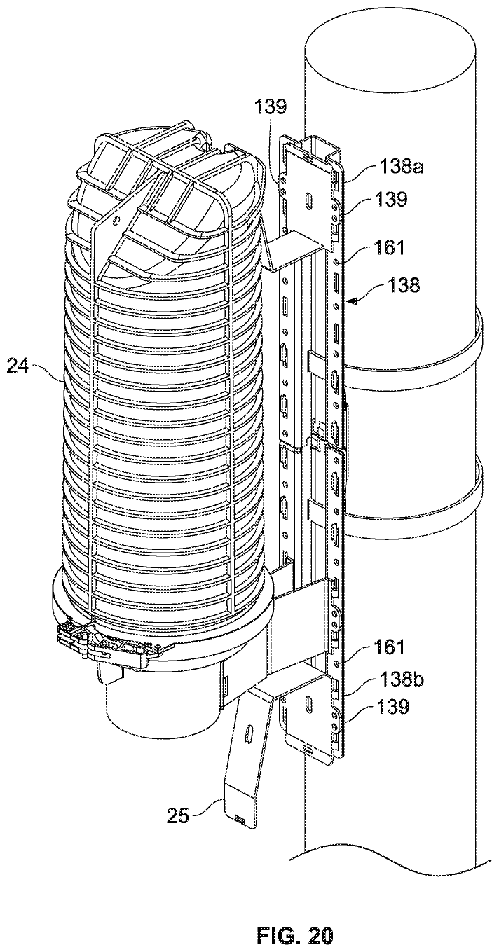

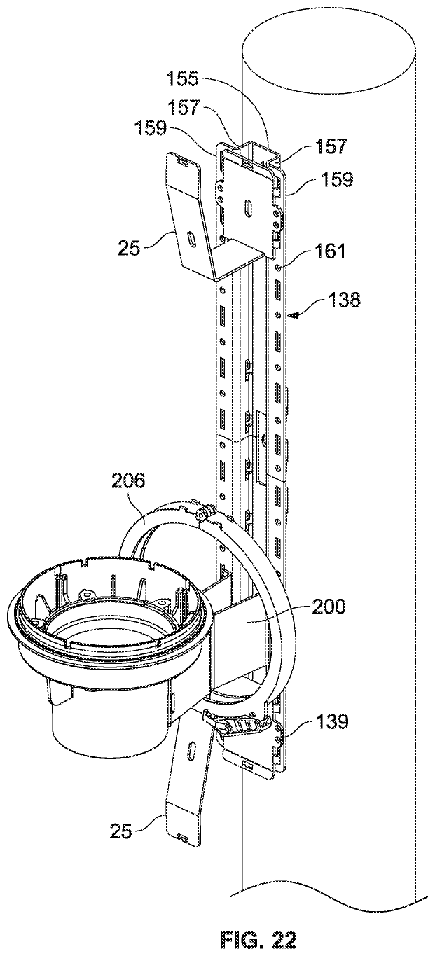

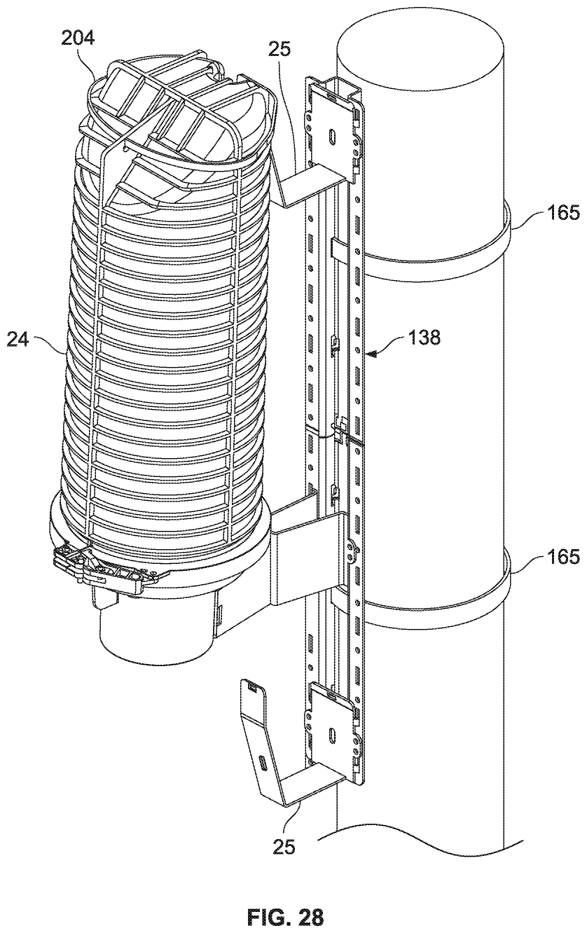

Referring to FIGS. 17 and 19-28, a forward offset bracket 200 mounts to the front flanges 159 (e.g., via retention tabs and/or fasteners in a manner comparable to the hooks 25). The cable management device 120 also includes the adapter bracket 122 (e.g., a terminal mounting bracket) that attaches to the forward offset bracket 200 for allowing a terminal (e.g., a dome-style terminal 24) to be mounted to the frame component 138. The dome-style terminal 24 can be secured to the adapter bracket 122 by fastening components such as bands or straps that may wrap around a base of the terminal 24. Additionally, as shown at FIGS. 26-28, a strap 204 can also be used to secure the dome of the terminal 24 to the cable management device 120. As depicted, the strap 204 is routed through an opening defined by the upper hook 25. As shown at FIG. 22, the forward offset bracket 200 can be used to temporarily stage/hold a collar clamp 206 that is used to secure the base of the dome-style closure to the dome of the dome-style terminal. The clamp 206 can be staged during initial installation of the terminal or during situations in which the dome is subsequently removed from the base in the field to allow access to fiber-optic components housed within the terminal.

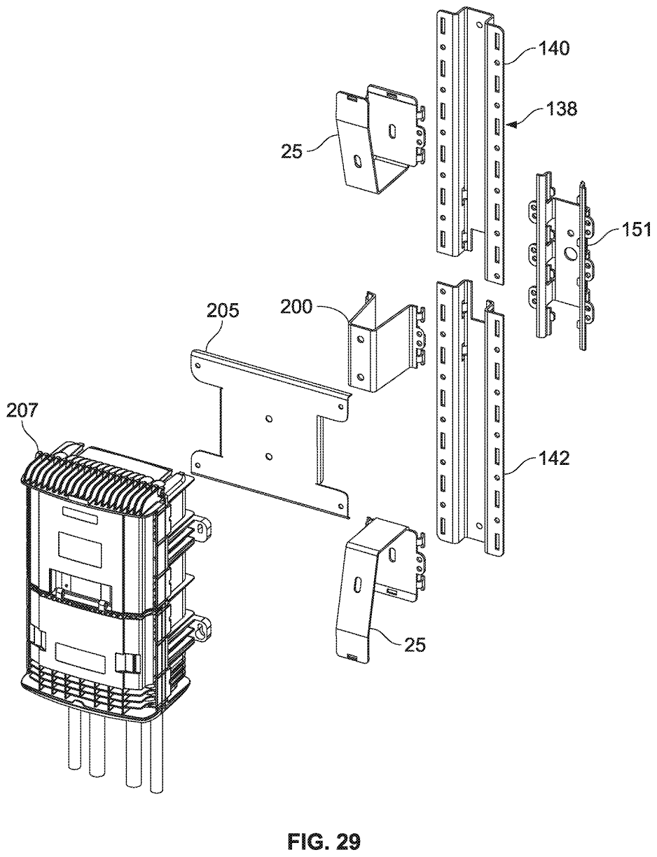

It will be appreciated that alternative terminal mounting brackets can also be secured to the forward offset bracket 200. For example, FIG. 29 depicts an alternative terminal mounting bracket 205 configured for allowing a box-style terminal 207 to be secured to the cable management device 120.

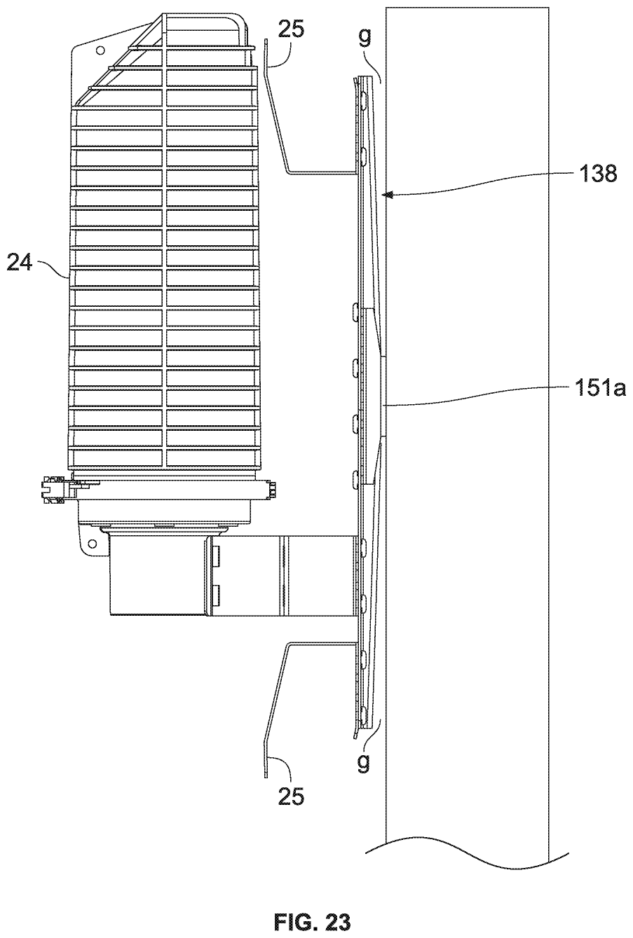

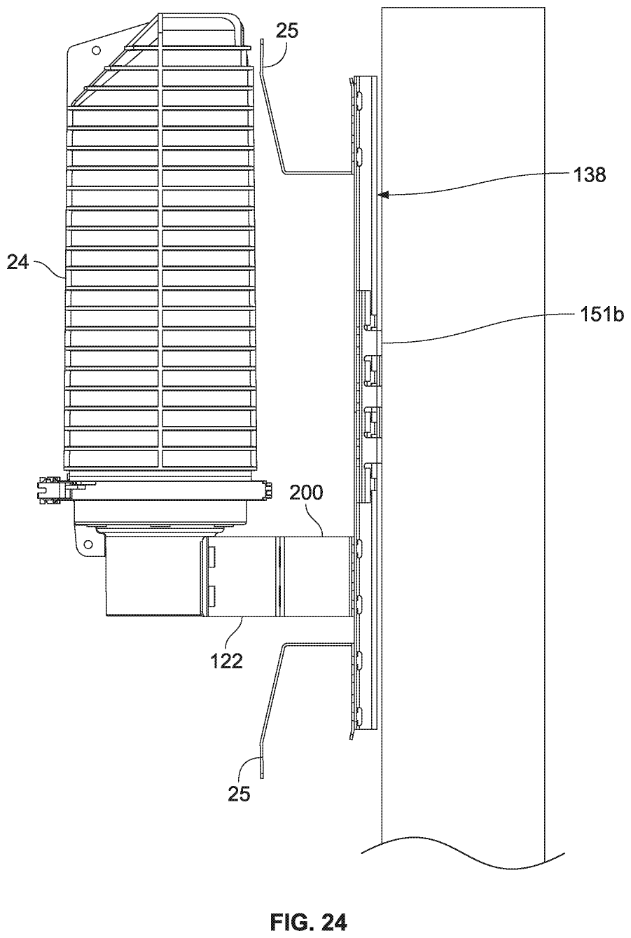

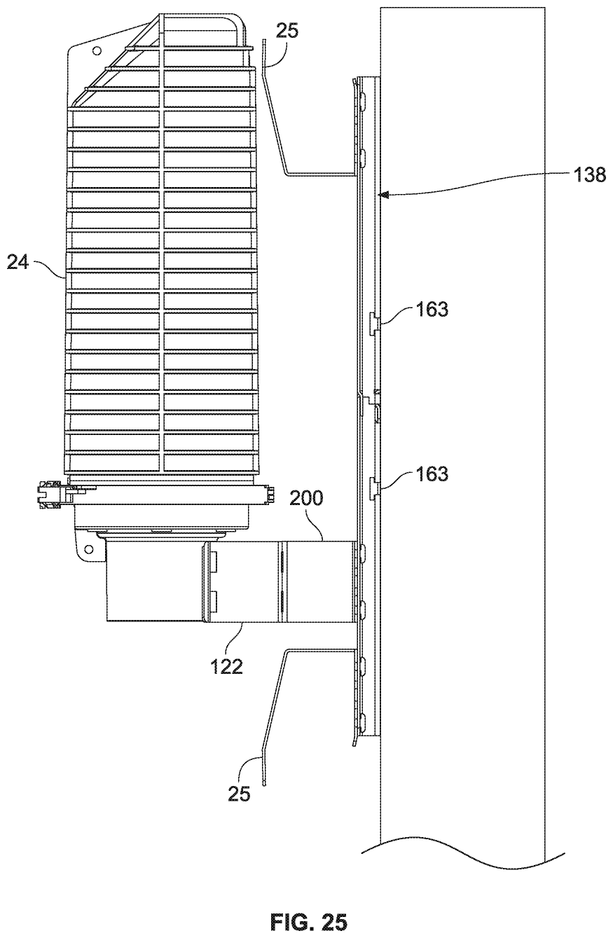

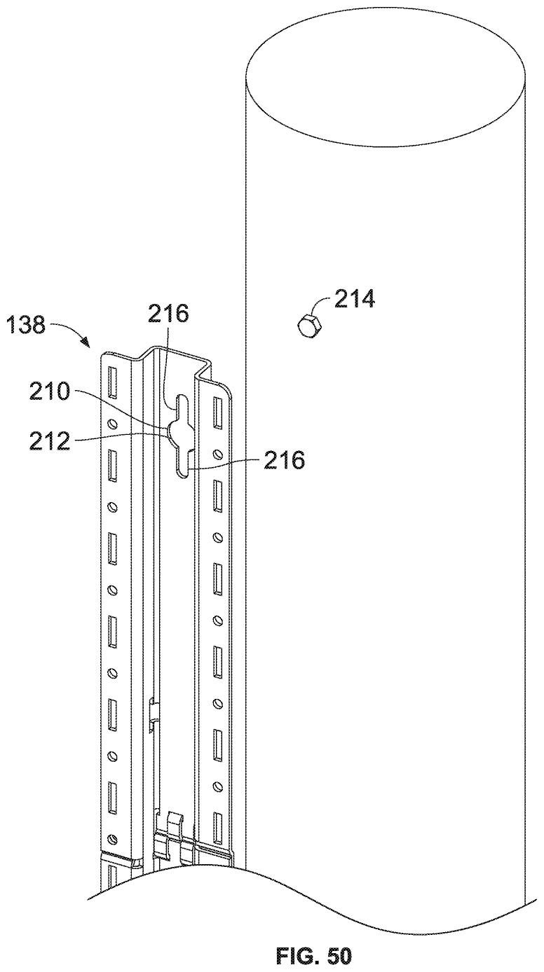

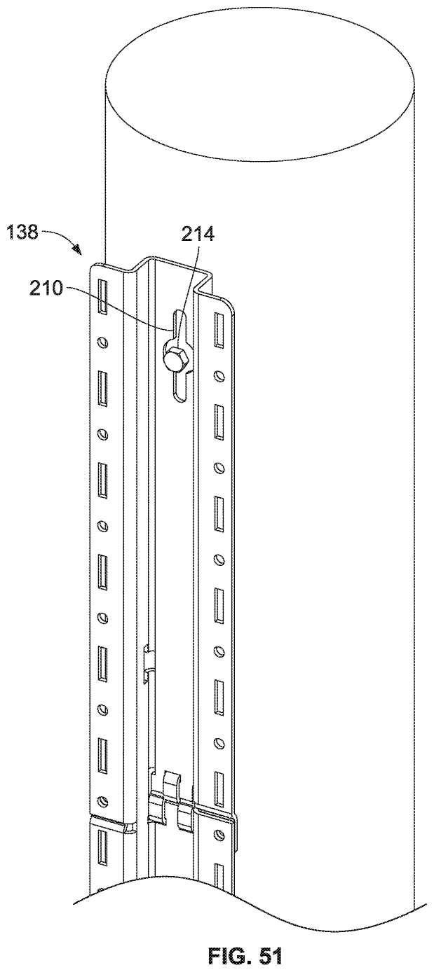

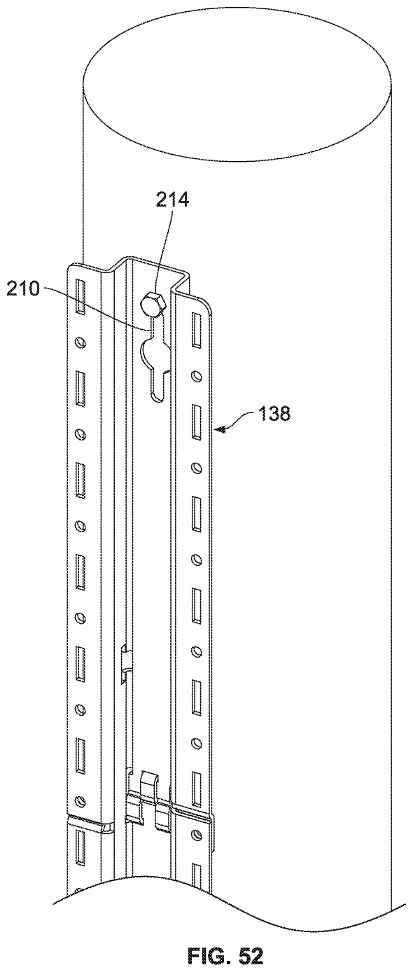

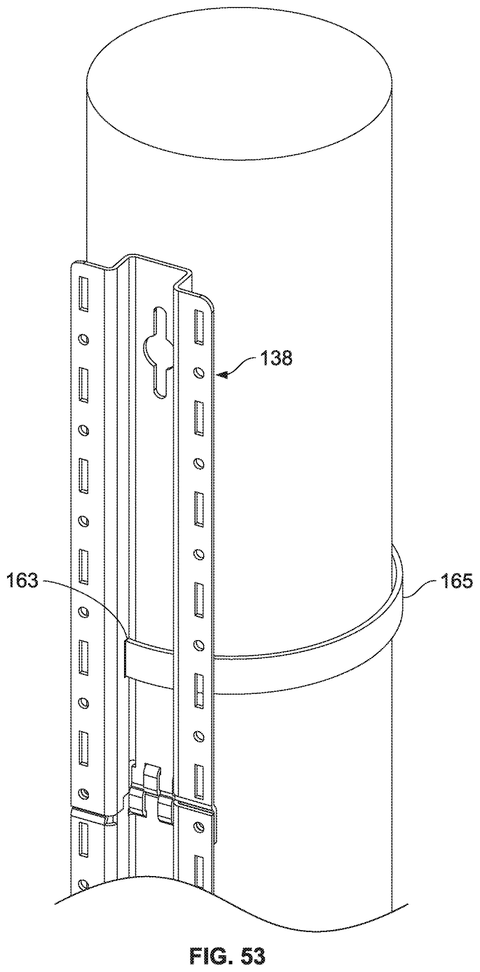

It will be appreciated that different types of device mounting brackets can be used to secure the frame component 138 to a structure such as a pole. FIG. 23 depicts a relatively short device mounting bracket 151a being used. In this example, the frame component 138 has a rear tapered configuration such that the frame component 138 is thicker in a front-to-rear orientation adjacent a central region as compared to adjacent the ends. Thus, when mounted to a structure such as a pole, the central region attaches to the pole via the device mounting bracket 151a and the rear taper provides gaps g between the pole and the backside of the frame component 138 adjacent the outer ends. FIG. 24 shows a variation having a longer device mounting bracket 151b. In this version, the frame component 138 has a constant thickness in the front-to-rear orientation along the length of the frame component 138. FIG. 25 depicts a version where the frame component 138 mounts directly to the structure such as a pole without an intermediate device mounting bracket. In this version, the frame component 138 can include fastener openings 210 defined through the rear wall as shown at FIGS. 50-53. The fastener openings 210 can include enlarged central head-receiving regions 212 for receiving the head of a fastener 214 secured to the pole, and upper and lower slot regions 216 into which the fastener 214 can be slid such that a portion of the rear wall is captured between the head of the fastener and the pole to provide securement of the frame component 138 (see FIG. 52). As previously described and as further shown at FIG. 53, straps 165 can also be used to secure the frame component 138 to a pole. The straps 165 can extend through slots 163 defined laterally through the frame component 138.

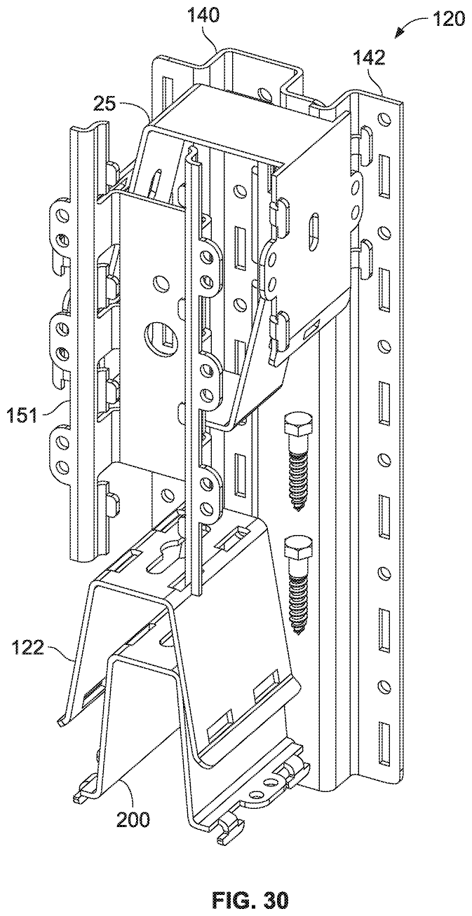

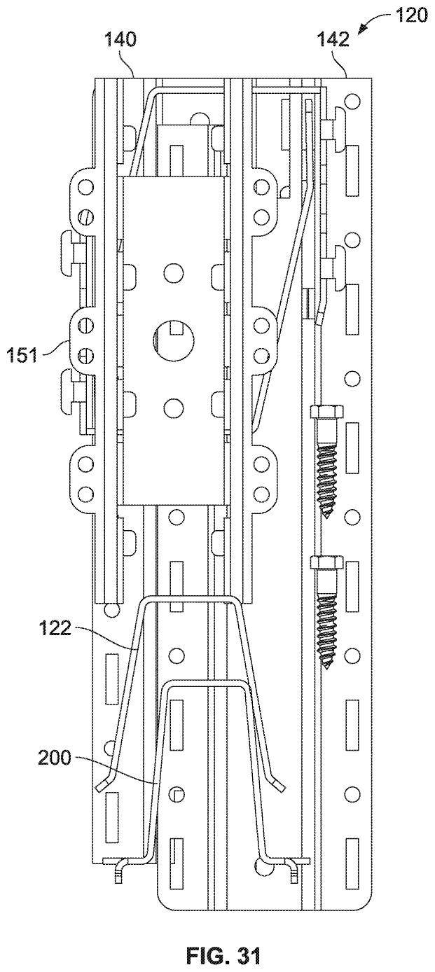

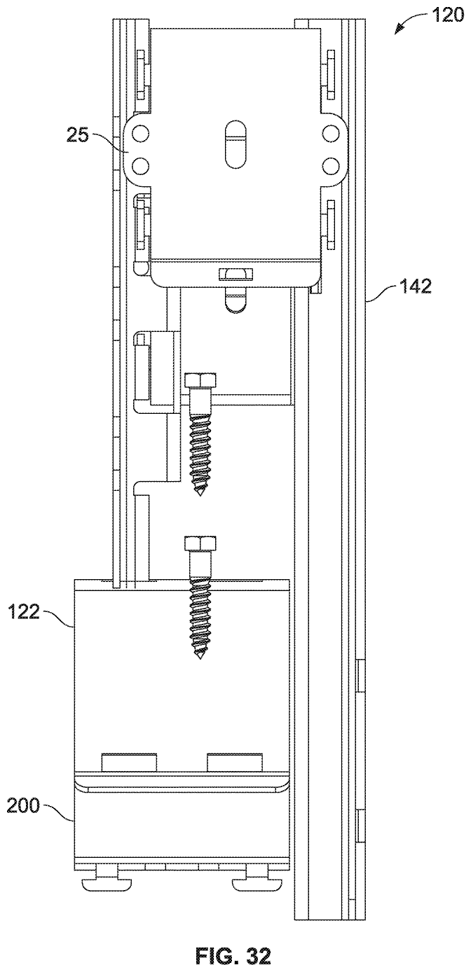

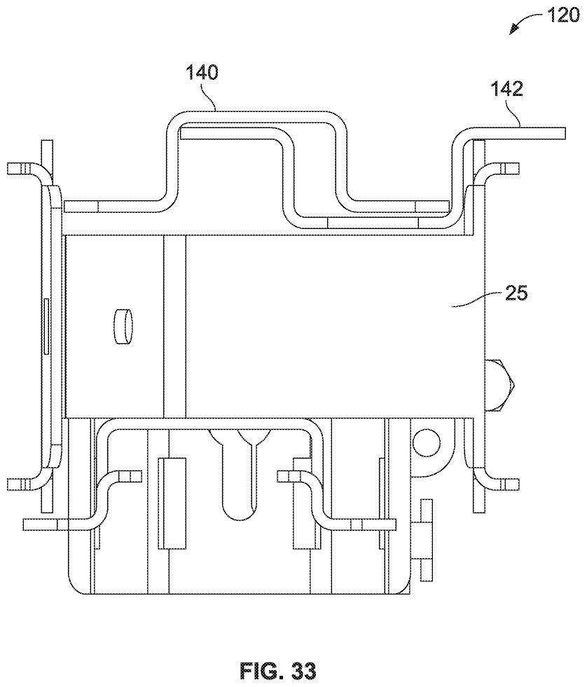

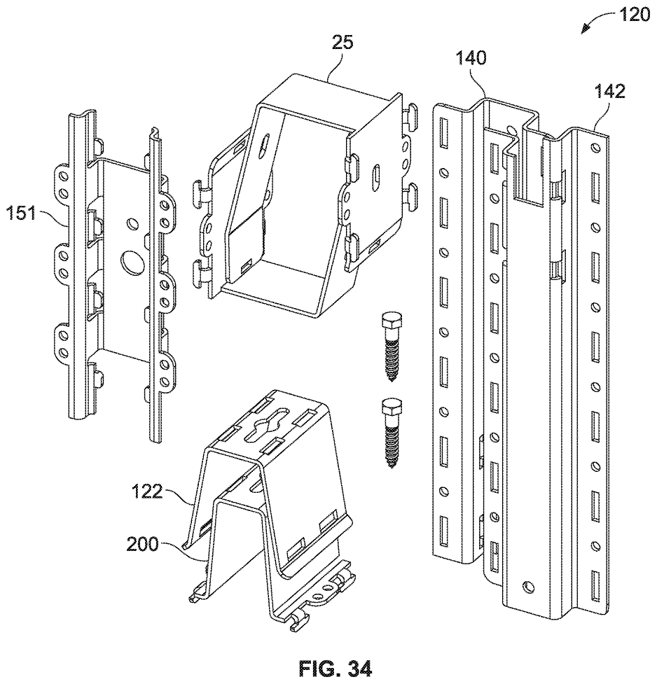

Referring to FIGS. 30-34, when the cable management device 120 is disassembled the various components can be arranged in a compact configuration for shipping. As depicted, the forward offset bracket and the terminal mounting bracket can nest with respect to one another. Similarly, the first and second frame members 140, 142 can be arranged in a longitudinally overlapped configuration in which the flange of one of the frame members 140, 142 fits within the channel of the other of the frame members 140, 142. Additionally, the hooks 25 can fit together in overlapping relation.

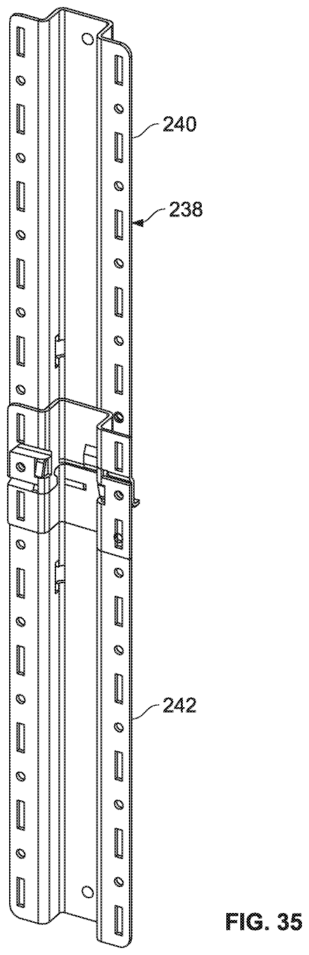

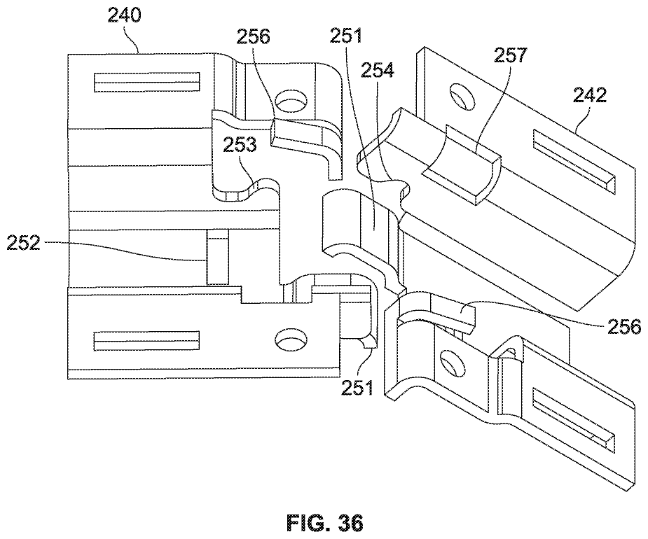

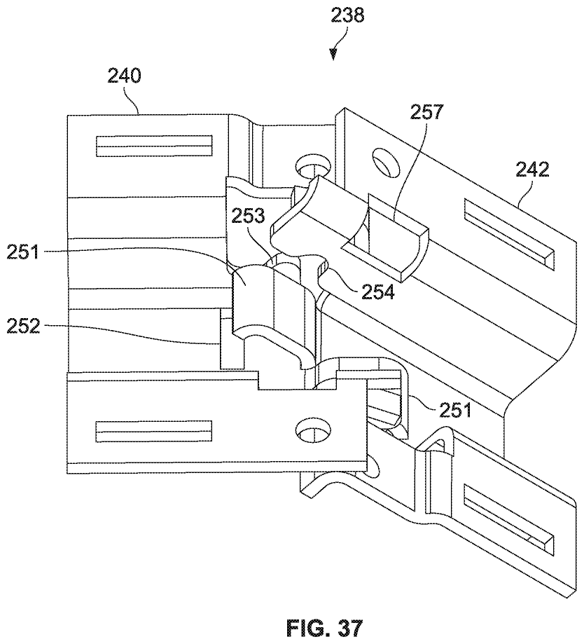

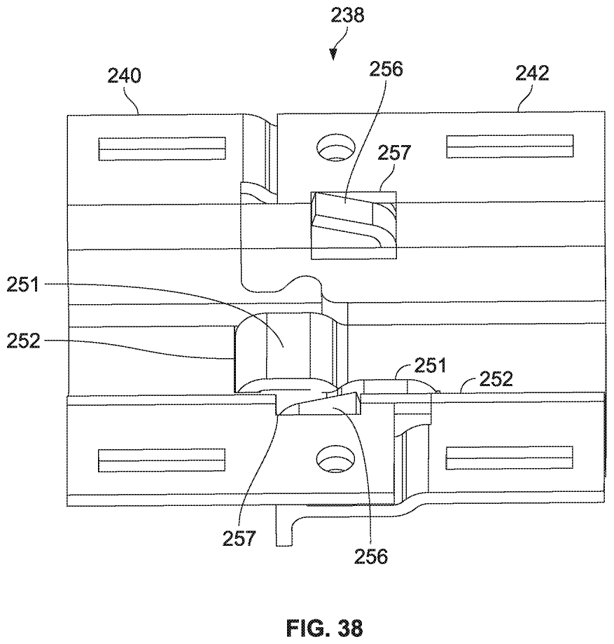

FIGS. 35-38 depict an alternative frame component 238 where first and second frame members 240, 242 interlock at their inner ends. The interlock interface includes interlock fingers 251 defined by the first and second frame members 240, 242 that fit into receptacles 252 defined by the first and second frame member 240, 242. The interlock interface also includes pivot guide members 253 of the first and second frame members 240, 242 that are received in pivot guide slots 254 defined by the first and second frame member 240, 242. The first and second frame members 240, 242 also each include cantilever members 256 that flex and snap into a retaining position within slots 257 defined by the first and second frame members 240, 242 when the first and second frame members 240, 242 are pivotally interlocked together. Fasteners can also be used to further secure the first and second frame members in the pivotally interlocked position.

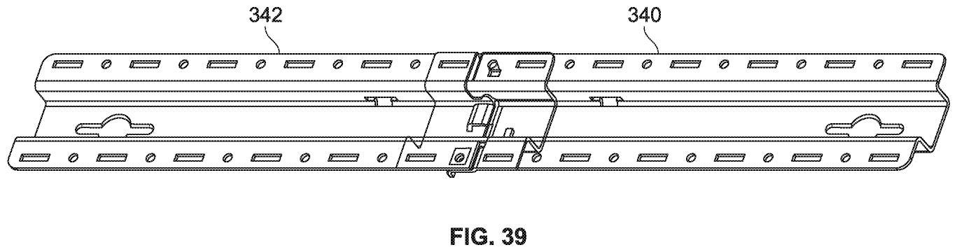

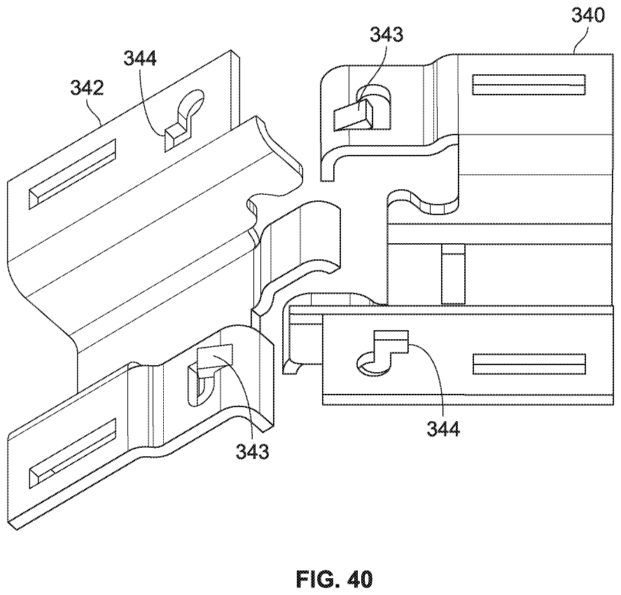

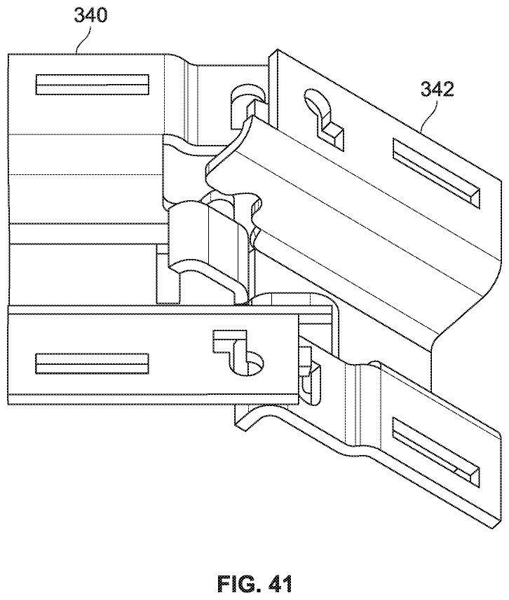

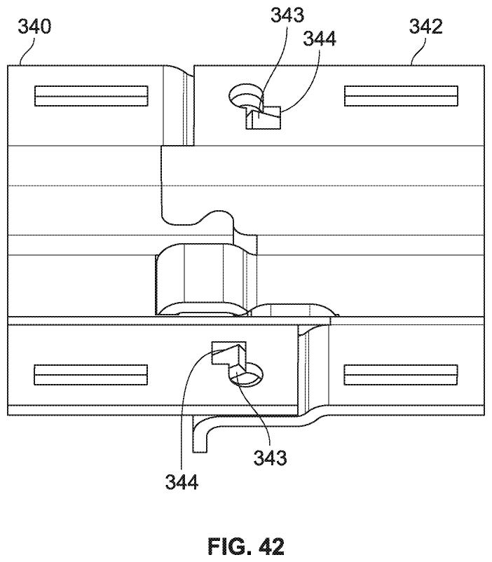

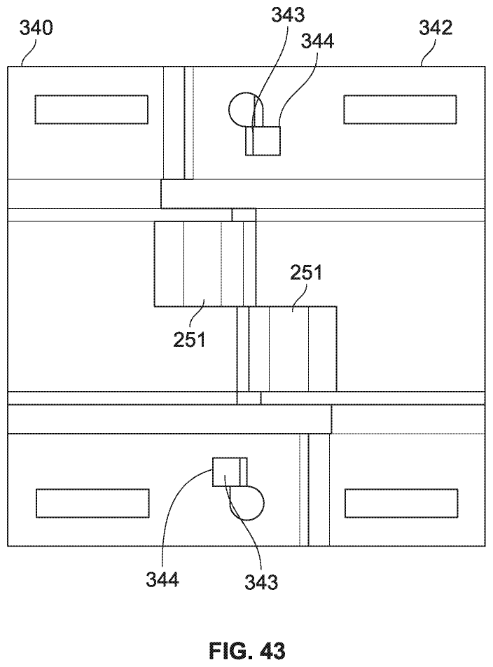

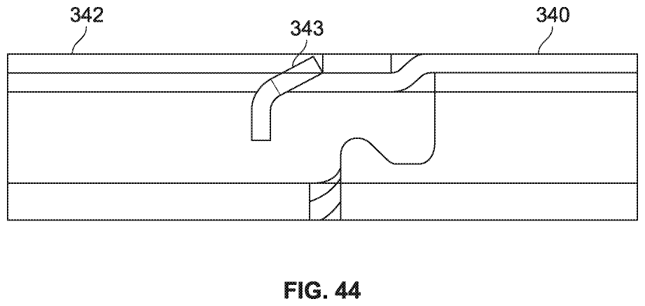

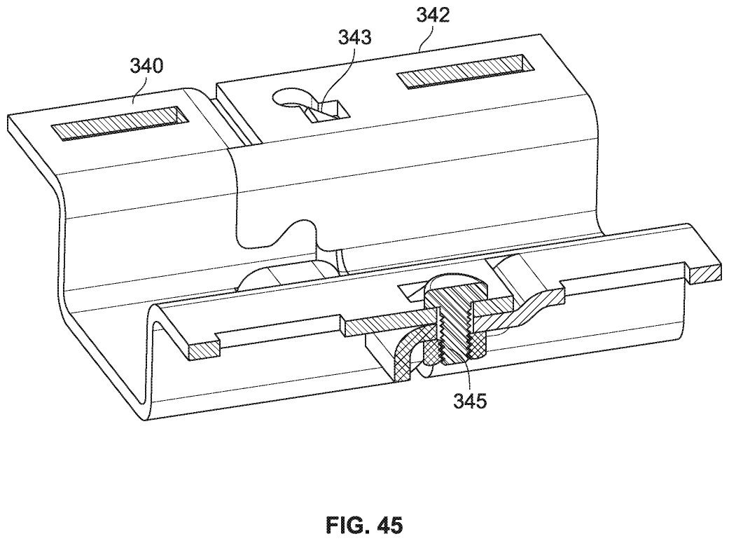

FIGS. 39-45 depict an alternative frame component 338 having another pivot interlock defined between first and second frame members 340, 342. The pivot interlock of the frame component 338 is similar to the pivot interlock of the frame component 238 except an alternative snap-fit arrangement including flexible cantilevers 343 that snap within openings 344 is utilized to assist in retaining the first and second frame members 340, 342 in the pivotally interlocked state. FIG. 45 depicts a fastener such as a threaded fastener 345 being used to further secure the first and second frame members 340, 342 in the pivotally interlocked state.

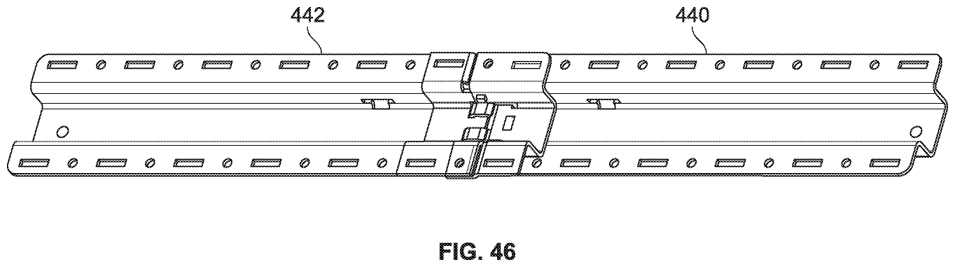

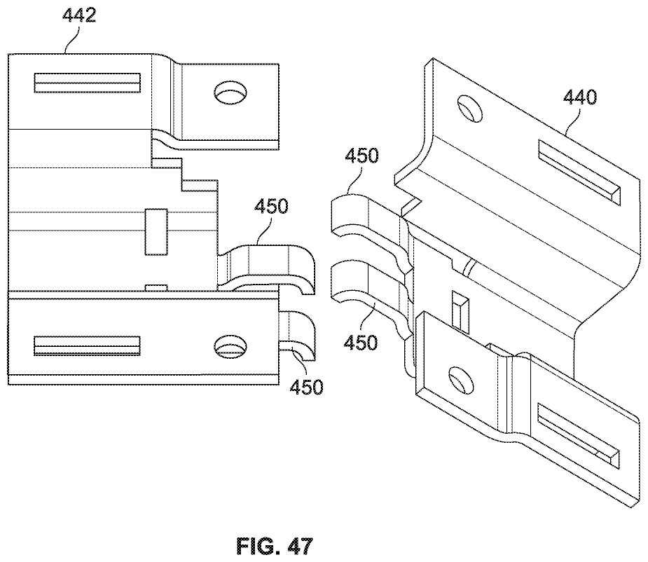

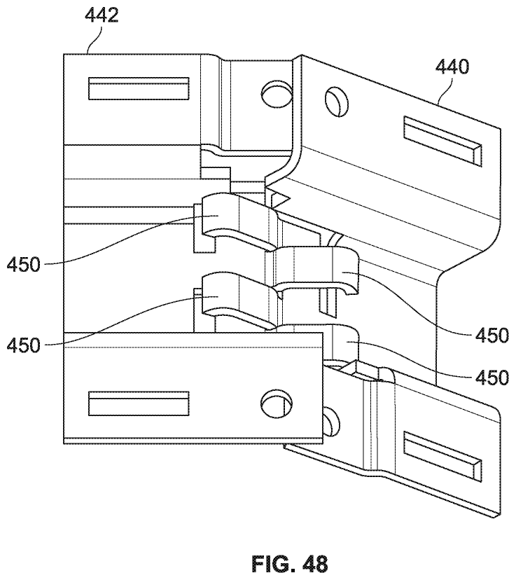

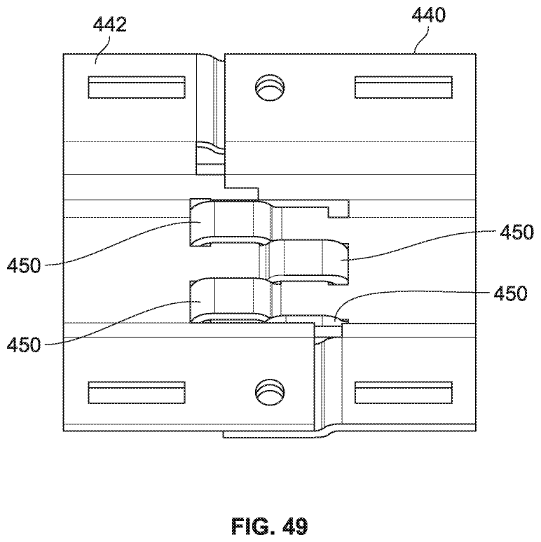

FIGS. 46-49 depict an alternative frame component 438 having another pivot interlock defined between first and second frame members 440, 442. The pivot interlock of the frame component 438 is configured such that the first and second frame members 440, 442 can have identical configurations. Each of the first and second frame members 440, 442 includes two interlock fingers 450 at their inner ends that are pivotally received within corresponding receptacles to provide the interlock. Fasteners such as threaded fasteners, cable ties or other fasteners can be used to secure the first and second frame members 440, 442 in the interlocked configuration.

The various examples described above are provided by way of illustration only and should not be construed to limit the scope of the present disclosure. Those skilled in the art will readily recognize various modifications and changes that may be made without departing from the true spirit and scope of the disclosed aspects.

What is claimed is:

1. A device for storing slack cable, the device comprising:
a cable coil support structure including a frame component including a length that extends along a reference plane between first and second end portions, the frame component including a first frame member and a second frame member that are secured in alignment with each other along the reference plane to define the frame component, wherein when the first and second frame members are secured in alignment with each other along the reference plane the first frame member defines the first end portion of the frame component and the second frame member defines the second end portion of the frame component;
the first and second end portions each including a hook mounting region including a plurality of hook mounting locations spaced-apart along the length of the frame component;
a first cable management hook that mounts at the hook mounting region of the first end portion of the frame component;
a second cable management hook that mounts at the hook mounting region of the second end portion of the frame component;
wherein the cable coil support structure has a two-location cable engagement configuration arranged such that the slack cable is coiled about only the first and second cable management hooks mounted on the frame component without any additional hooks for engaging the coiled slack cable.

2. The device of claim 1, further comprising an adapter bracket that attaches to the frame component at a mid-region of the frame component for allowing a terminal to be mounted to the frame component.

3. The device of claim 1, wherein the first and second cable management hooks are reversibly mountable at the hook mounting regions.

4. The device of claim 1, wherein the hook mounting locations include hook mounting slots, and wherein the first and second cable management hooks include retention tabs that fit in the slots to secure the first and second cable management hooks to the hook mounting regions, the retention tabs having T-shaped profiles that allow the first and second cable management hooks to be reversible mountable at the hook mounting regions.

5. The device of claim 1, wherein the frame component has a front side and a back side, wherein the back side is adapted to face toward a structure such as a pole when the device is secured to the structure, wherein the frame component includes a central front platform, wherein the device includes an adapter bracket that mounts to the central front platform for attaching a terminal mounting bracket to the frame component, and wherein the central platform is forwardly offset with respect to the first and second end portions of the frame component by forward/rearward offset sections of the frame component.

6. The device of claim 5, wherein the central front platform includes a first platform section defined by the first frame member and a second platform section defined by the second frame member, wherein the first platform section overlaps the second platform section when the first and second frame members are secured together, wherein the first platform section includes an end tab that fits in a slot defined by the second platform section, wherein the first platform section includes rearwardly projecting longitudinal edge rails between which the second platform section extends, and wherein one or more fasteners are further provided for securing the first and second platform sections together.

7. The device of claim 6, wherein the first and second end portions of the frame component each define a rearwardly facing channel formed by a front wall and two rearwardly projecting side legs, wherein the hook mounting slots are defined through the front walls and wherein strap receiving slots are defined through the side legs.

8. The device of claim 6, wherein the frame component includes device mounting tabs at the first and second end portions, the device mounting tabs being rearwardly offset from the front walls, and the device mounting tabs defining fastener openings for receiving fasteners for use in securing the device to the structure.

9. The device of claim 1, wherein the first and second frame members have identical configurations.

10. The device of claim 1, further comprising a device mounting bracket having a front side and a back side, wherein the back side is adapted to face toward a structure such as a pole when the device is secured to the structure, and wherein the first and second frame members mount at the front side of the device mounting bracket.

11. The device of claim 1, wherein the first and second frame members are configured to interlock with each other.

12. The device of claim 11, wherein the first and second frame members interlock with each other via a pivotal interlock interface.

13. The device of claim 1, wherein the first and second cable management hooks define strap-receiving openings.

14. The device of claim 1, wherein the first and second frame members each have a front side and a back side, wherein the back sides are adapted to face toward a structure such as a pole when the device is secured to the structure, wherein the first and second frame members each have a frame profile defining a longitudinal channel, wherein open sides of the longitudinal channels face forwardly, wherein the frame profile is defined by a rear wall, channel-defining legs that project forwardly from the rear wall, and front flanges that project laterally outwardly from forward ends of the legs.

15. The device of claim 14, wherein the hook mounting regions include hook mounting slots defined through the front flanges, and wherein the first and second cable management hooks include retention tabs that fit in the slots to secure the first and second cable management hooks to the hook mounting regions, the retention tabs having T-shaped profiles that allow the first and second cable management hooks to be reversible mountable at the hook mounting regions.

16. The device of claim 15, further comprising a forward offset bracket that mounts to the front flanges, the device also including an adapter bracket that attaches to the forward offset bracket for allowing a terminal to be mounted to the frame component.

17. The device of claim 15, further comprising a device mounting bracket having a front side and a back side, wherein the back side of the device mounting bracket is adapted to face toward a structure such as a pole when the device is secured to the structure, wherein the first and second frame members mount at the front side of the device mounting bracket, wherein the device mounting bracket has a forward facing channel that receives the back sides of the first and second frame members, and wherein the front flanges of the first and second frame members are secured to the device mounting bracket by fasteners.

18. The device of claim 10, wherein the first and second frame members each attach to the device mounting bracket by both an interlock interface and threaded fasteners.

19. The device of claim 10, wherein inner ends of the first and second frame members cooperate to define an opening for accessing a structure attachment region of the device mounting bracket.

20. The device of claim 1, wherein the frame component has a rear side that is tapered such that a depth of the frame component is larger at a mid-region of the frame component as compared to at the first and second end portions.

21. A device for storing slack cable, the device comprising:
a cable coil support structure including a frame component defining hook mounting regions;
cable management hooks that are configured to reversibly mount at the hook mounting regions.

22. The device of claim 21, wherein the hooks are mountable in a first configuration in which open sides of the hooks face outwardly and are also mountable in a second configuration where the open sides face inwardly.

23. The device of claim 22, wherein the hooks have retention tabs with T-shaped profiles that fit within slots defined at the hook mounting regions.

24. A device for storing slack cable, the device comprising:
a cable coil support structure including a frame component including a length that extends along a reference plane between first and second end portions, the frame component including a first frame member and a second frame member that are secured in alignment with each other along the reference plane to define the frame component, wherein when the first and second frame members are secured in alignment with each other along the reference plane the first frame member defines the first end portion of the frame component and the second frame member defines the second end portion of the frame component;
the first and second end portions each including a hook mounting region including a plurality of hook mounting locations spaced-apart along the length of the frame component;
a first cable management hook that mounts at the hook mounting region of the first end portion of the frame component;
a second cable management hook that mounts at the hook mounting region of the second end portion of the frame component;
wherein the frame component has a front side and a back side, wherein the back side is adapted to face toward a structure such as a pole when the device is secured to the structure, wherein the frame component includes a central front platform, wherein the device includes an adapter bracket that mounts to the central front platform for attaching a terminal mounting bracket to the frame component, and wherein the central platform is forwardly offset with respect to the first and second end portions of the frame component by forward/rearward offset sections of the frame component.

25. A device for storing slack cable, the device comprising:
a cable coil support structure including a frame component including a length that extends along a reference plane between first and second end portions, the frame component including a first frame member and a second frame member that are secured in alignment with each other along the reference plane to define the frame component, wherein when the first and second frame members are secured in alignment with each other along the reference plane the first frame member defines the first end portion of the frame component and the second frame member defines the second end portion of the frame component;
the first and second end portions each including a hook mounting region including a plurality of hook mounting locations spaced-apart along the length of the frame component;
a first cable management hook that mounts at the hook mounting region of the first end portion of the frame component;
a second cable management hook that mounts at the hook mounting region of the second end portion of the frame component;
wherein the first and second frame members are identical.

26. A device for storing slack cable, the device comprising:
a cable coil support structure including a frame component including a length that extends along a reference plane between first and second end portions, the frame component including a first frame member and a second frame member that are secured in alignment with each other along the reference plane to define the frame component, wherein when the first and second frame members are secured in alignment with each other along the reference plane the first frame member defines the first end portion of the frame component and the second frame member defines the second end portion of the frame component;
the first and second end portions each including a hook mounting region including a plurality of hook mounting locations spaced-apart along the length of the frame component;
a first cable management hook that mounts at the hook mounting region of the first end portion of the frame component;
a second cable management hook that mounts at the hook mounting region of the second end portion of the frame component;
a device mounting bracket for mounting the frame component to a structure such as a pole, the device mounting bracket being secured at an interface between the first and second frame members.
